(19) United States
(12) Patent Application Publication
(10) Pub. No.: US 2014/0293488 A1
(43) Pub. Date: Oct. 2, 2014

(54) PROTECTING AGAINST TRANSIENTS IN A POWER CONTROL SYSTEM

(71) Applicant: VETCO GRAY CONTROLS LIMITED, Bristol (GB)

(72) Inventors: Julian Richard DAVIS, Bristol (GB); Silviu PUCHIANU, Bristol (GB); Graham Thomas MORLEY, Bristol (GB)

(73) Assignee: VETCO GRAY CONTROLS LIMITED, Bristol (GB)

(21) Appl. No.: 14/227,199

(22) Filed: Mar. 27, 2014

(30) Foreign Application Priority Data
Mar. 28, 2013 (EP) 13161586.6

(51) Int. Cl. H02H 9/00

(52) U.S. Cl. CPC H02H 9/002
USPC 361/18

(57) ABSTRACT

A system for providing alternating current to at least one inductive load, the system including at least one switching means for switching power to the load on and off, controller adapted for controlling the at least one switching means and a pre-magnetization device, wherein the pre-magnetization device is configured to generate pulses which cause the switching means to pre-magnetize the inductive load.

### BACKGROUND OF THE INVENTION

Embodiments of the present invention relate to protecting against transients and inrush currents in a power control system, for example in a subsea fluid production well power control system.

In subsea fluid production well power control systems, the voltage transients inherently associated with power on/off switching of inductive loads are potentially very damaging, because communication modems are directly coupled (connected electrically) to power lines in order to implement communication on power (COP) systems. High voltage transients may damage topside and subsea modems used in COP-based communication systems and topside and subsea power distribution transformers.

The switching of AC power to a transformer is typically achieved in modern power control systems by semiconductor switches such as silicon controlled rectifiers (SCRs), triacs and gate turn off thyristors (GTOs). Prior art methods, such as those disclosed in WO 01/03323, U.S. Pat. No. 5,563,459, U.S. 2006/262881 and U.S. Pat. No. 4,745,515, teach that to minimise inrush currents to the transformer primary, it is prudent to phase control the switching off of the semiconductor devices at the point of the AC waveform when the input current falls to zero, thereby ensuring that the magnetic remanance in the transformer core is zero and thus will not go into saturation when the AC supply is restored. However, this precaution has no value if the AC power source is inadvertently removed when current is flowing in the transformer primary, i.e. not a zero current phase controlled switching off, leaving remanance in the core, and potentially saturation and large inrush currents at restoration of the power source.

This situation is avoided by the invention disclosed in European Patent Application No. 11194360.1, which describes a method of preventing switching on transients in transformer fed power supply systems by injecting a DC current from a DC power supply source at switching off, thus pre-magnetising the transformer core to a low remanance so that the inrush current at the next switching on is minimised.

### SUMMARY OF THE INVENTION

Embodiments of the present invention remove the need for a separate DC power supply to achieve the same pre-magnetisation.

According to the present invention from one aspect, there is provided a system for providing alternating current to at least one inductive load, the system including at least one switching means for switching power to the at least one load on and off, control means adapted for controlling the at least one switching means and a pre-magnetization means, wherein the pre-magnetization means is configured to generate pulses which cause the switching means to pre-magnetize the inductive load.

According to the present invention from another aspect, there is provided a method for providing alternating current to at least one inductive load, comprising the steps of: providing at least one switching means for switching power to the at least one load on and off; providing a control means adapted for controlling the at least one switching means; and using a pre-magnetization means to generate pulses which cause the switching means to pre-magnetize the inductive load.

The control means could comprise a zero voltage crossing comparator and phase control logic, and the output of the comparator could be used by the phase control logic to control the switching means to switch power to the at least one load on and off in phase with an input alternating current at a positive going crossing point of the alternating current waveform.

The pre-magnetization means could comprise a pre-magnetization pulse generator.

The pre-magnetization means could comprise pre-magnetization control logic configured to control the pre-magnetization pulse generator to generate a train of pulses, wherein each pulse controls the switching means to switch power to the at least one load on prior to a negative going crossing point of the alternating current waveform.

The alternating current waveform could comprise a sine wave.

The at least one inductive load could comprise a winding of a transformer.

A system according to an embodiment of the present invention typically comprises a power control system for a subsea well and a method according to an embodiment of the present invention typically is performed in such a system.

### BRIEF DESCRIPTION OF THE DRAWINGS

FIG. 1 is a schematic diagram of an embodiment of an electronic power control system in accordance with the present invention;

FIG. 2 is an oscilloscope trace of voltage and current measured in the system of FIG. 1 at switching on, without pre-magnetization of the transformer coil in accordance with the present invention;

FIG. 3 is an oscilloscope trace of voltage and current measured in the system of FIG. 1 when pre-magnetization is applied prior to switching on in accordance with the present invention; and

FIG. 4 is an oscilloscope trace of voltage and current measured in the system of FIG. 1 at switching on, when pre-magnetization has been applied prior to switching on in accordance with the present invention.

### DETAILED DESCRIPTION OF THE EXEMPLARY EMBODIMENTS OF THE INVENTION

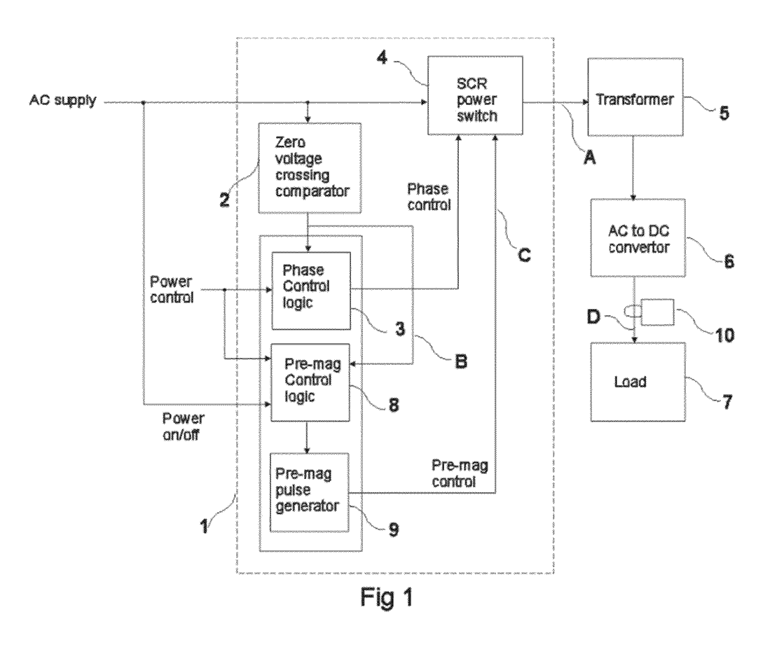

FIG. 1 shows a typical electronic power control system which employs a SCR power switch as the semiconductor switching device. In this example, the load is a subsea electronics module (SEM) which is part of a subsea fluid (e.g. hydrocarbon) production well control system. However, the present invention may be applied to any transformer fed system.

The power control system 1 conventionally consists of a zero voltage crossing comparator 2, feeding phase control logic 3, which ensures that, under controlled conditions the switching on and off of a SCR power switch 4 occurs when the AC supply voltage is at the zero voltage crossing point. The switched power from the SCR power switch 4 feeds a transformer 5, the output of which feeds an AC to DC converter 6, which in turn supplies power to a DC load 7 (in this case, a SEM). The embodiment of the present invention is a modification to this arrangement, specifically including the addition of transformer pre-magnetization logic 8, controlling a pulse generator 9, which produces pre-magnetization DC power generation by the SCR power switch 4 to the transformer 5.

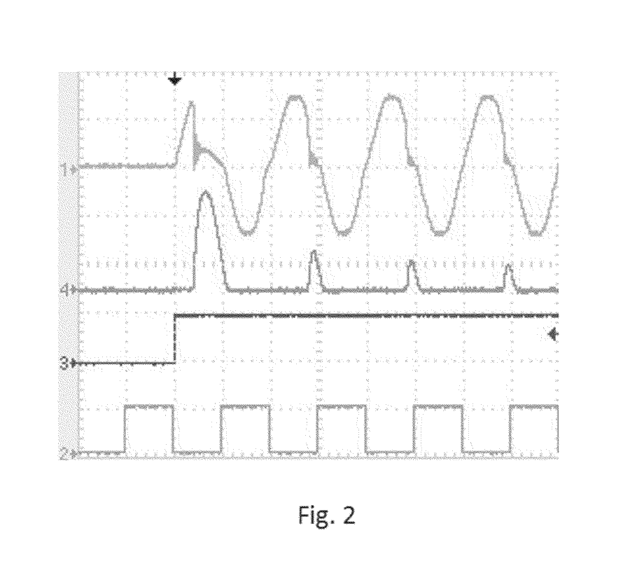

FIG. 2 will now be described, in which:
Channel 1 represents the output voltage from the SCR power switch 4 input to the transformer 5 (via an isolation amplifier), with 500V per division. This is measured at point A in FIG. 1.
Channel 2 represents the zero voltage crossing comparator output, with 5V per division. This is measured at point B in FIG. 1.
Channel 3 represents the switch gate control signal for the SCR power switch 4, with 5V per division (and 5V representing switching on of SCR power switch 4). This is measured at point C in FIG. 1.
Channel 4 represents the load (SEM) current, with 5V per division, monitored by a DC current probe set to 1 A per 10 mV (100 A per Volt). This is measured at point D in FIG. 1.

FIG. 2 illustrates switching on of the supply to the transformer 5 after the transformer has been switched off with a significant magnetic remanance in its core with the phase control logic 3 and the pre-magnetization control logic 8 disabled, such that the SCR power switch 4 is switched on at the positive going zero crossing point of the input sine waveform. As can be seen on channel 1, the input voltage rises but soon results in transformer core saturation, which results in a very large inrush current (see channel 4) which further results in serious distortion of the input supply voltage waveform and consequential voltage transients which can damage the supply load. The effect can also be seen to persist over several cycles of the supply voltage.

It is this effect which results in potential damage due to transients when the supply is accidentally removed (e.g. by a circuit breaker opening) which cannot be prevented by conventional phase control of the SCR power switch 4.

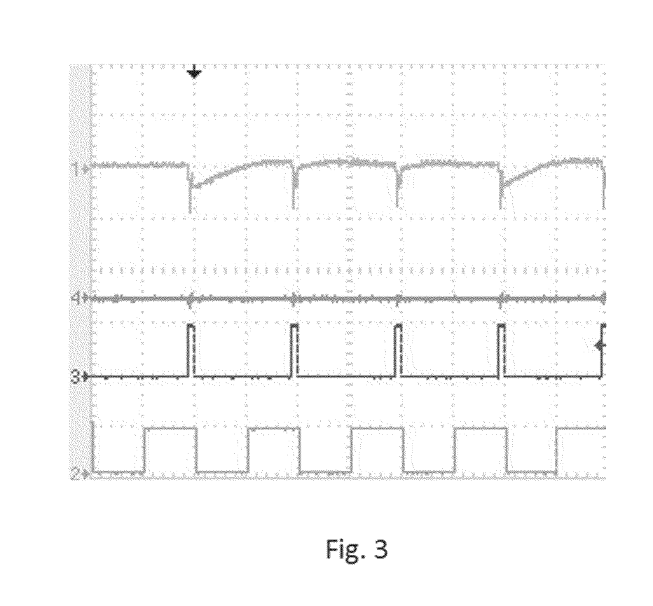

FIG. 3 illustrates the operation of the pre-magnetization modification of the SCR power switch 4 control circuitry, in accordance with the embodiment of the present invention. Prior to switching on occurring, following a power on command to the power control system 1, the AC supply causes the pre-magnetization logic 8 to instruct the pre-magnetization pulse generator 9 output a train of short duration SCR switching on pulses (see channel 3) to turn on the SCR power switch 4 just before the previous input voltage negative half sine wave reaches the zero voltage crossing point, which results in the SCR power switch 4 switching off. Note that this occurs on the negative half sine wave only. The correct switching on point is triggered by the pre-magnetization logic 8 from the zero crossing point detector 2 (see channel 2). This train of short SCR switching on pulses on the negative half sine wave cycles only results in a small negative DC supply voltage being applied to the transformer, which ensures that the remanance in its core is small and slightly negative relative to the next turn on cycle, i.e. set to prevent transformer core saturation when the next positive sine wave supply voltage is applied at switching on. The train of pre-magnetization pulses is switched off after a few cycles, whereupon the phased controlled switching on process by phase control logic 3 is allowed to initiate the switching on cycle.

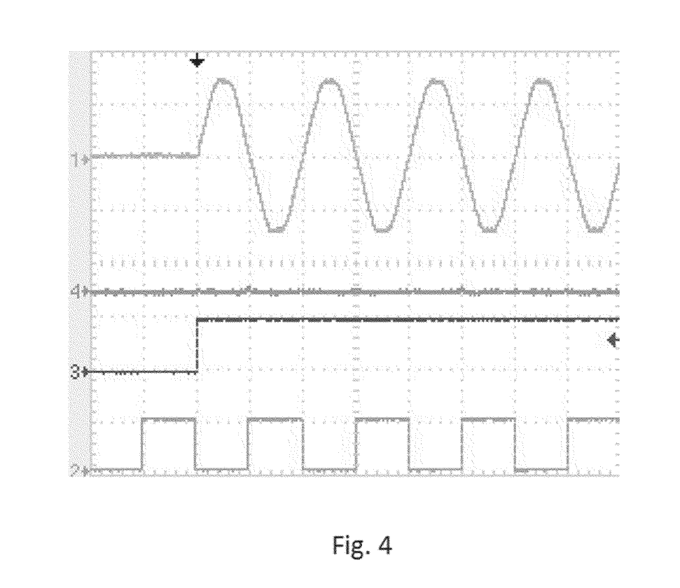

FIG. 4 shows the resultant oscilloscope trace of the four channels referred to previously when pre-magnetization has been applied prior to the phase controlled switching on process. The input current surge on channel 4 and the input supply waveform distortion on channel 1 are drastically reduced compared to FIG. 2. These traces were recorded after the transformer 5 had been deliberately set to have a high core remanance and connected to the system.

Transformers supplying the electronics of subsea fluid extraction wells must be relied upon not to be the source of damaging voltage transients as they are located subsea, often beneath many kilometres of sea water. Consequently, they are very expensive to recover and repair. The present invention enables a substantial reduction of the risk of such damaging transients and thus potentially saves well operators major operating costs.

Although the present invention has been described with reference to particular embodiments, this description generally aims to set forth the inventive ideas and should not be taken to limit the scope of the present invention, and the scope of the present invention will be defined by the appended claims. Of course, those skilled in the art will also be appreciated that the present invention may be performed in other ways than those specifically described herein, without departing from the basic characteristics of the present invention. The present embodiments are thus to be considered in all respects as illustrative and not restrictive, and all changes which come within the meaning and range of equivalency of the appended claims are intended to included therein.

What is claimed is:

1. A system for providing alternating current to at least one inductive load, the system comprising:
at least one switch for switching power to the at least one inductive load on and off;
a controller configured to control the at least one switch; and
a pre-magnetization device, wherein the pre-magnetization device is configured to generate pulses which cause the at least one switch to pre-magnetize the at least one inductive load.

2. The system according to claim 1, wherein the controller comprises a zero voltage crossing comparator and phase control logic, and wherein the output of the comparator is used by the phase control logic to control the at least one switch to switch power to the at least one inductive load on and off in phase with an input alternating current at a positive going crossing point of the alternating current waveform.

3. The system according to claim 2, wherein the pre-magnetization device comprises a pre-magnetization pulse generator.

4. The system according to claim 3, wherein the pre-magnetization device further comprises pre-magnetization control logic configured to control the pre-magnetization pulse generator to generate a train of pulses, wherein each pulse of the train of pulses controls the at least one switch to switch power to the at least one inductive load on prior to a negative going crossing point of the alternating current waveform.

5. The system according to claim 1, wherein the at least one inductive load comprises a winding of a transformer.

6. The system according to claim 2, wherein the alternating current waveform is a sine wave.

7. The system according to claim 1, further comprising a power control system for a subsea well.

8. A method for providing alternating current to at least one inductive load, the method comprising:
providing at least one switch for switching power to the at least one inductive load on and off;
providing a controller configured to control the at least one switch; and
using a pre-magnetization device to generate pulses which cause the at least one switch to pre-magnetize the at least one inductive load.

9. The method according to claim 8, wherein the controller comprises a zero voltage crossing comparator and phase control logic, and wherein the output of the comparator is used by the phase control logic to control the at least one switch to switch power to the at least one inductive load on and off in phase with an input alternating current at a positive going crossing point of the alternating current waveform.

10. The method according to claim 9, wherein the pre-magnetization device comprises a pre-magnetization pulse generator.

11. The method according to claim 10, wherein the pre-magnetization device further comprises pre-magnetization control logic configured to control the pre-magnetization pulse generator to generate a train of pulses, wherein each pulse of the train of pulses controls the at least one switch to switch power to the at least one inductive load on prior to a negative going crossing point of the alternating current waveform.

12. The method according to claim 8, wherein the at least one inductive load comprises a winding of a transformer.

13. The method according to claim 8, wherein the method is performed in a power control system for a subsea well.
